(19) United States
(12) Patent Application Publication
(10) Pub. No.: US 2026/0347184 A1
(43) Pub. Date: Nov. 5, 2026

(54) OZONE CARTRIDGE WITHOUT ION EXCHANGE MEMBRANE

(71) Applicant: Delta Faucet Company, Indianapolis, IN (US)

(72) Inventors: Michael Scot Rosko, Greenwood, IN (US); Bradley D. Terry, Waterford, MI (US)

(21) Appl. No.: 19/661,519

(22) Filed: Apr. 28, 2026

Related U.S. Application Data
(60) Provisional application No. 63/797,376, filed on Apr. 30, 2025.

(51) Int. Cl. C01B 13/11

(52) U.S. Cl. CPC C01B 13/115; C01B 2201/22; C01B 2201/24

(57) ABSTRACT

An ozone generator includes an outer cartridge and an electrolytic cell assembly received within the outer cartridge. The illustrative electrolytic cell assembly includes a first current spreader operably coupled to a first housing. A first electrode is in electrical communication with a planar body of a first current spreader. A first frame receives the first electrode. A second housing is operably coupled to the first housing. A second current spreader is operably coupled to the second housing. A second electrode is in electrical communication with a planar body of a second current spreader. A second frame receives the second electrode. A spacer intermediate the first frame and the second frame defines a desired distance between the first electrode and the second electrode. The ozone generator may be configured for use with a fluid delivery device, illustratively a plumbing product, such as a faucet.

### CROSS-REFERENCE TO RELATED APPLICATION

The present application claims priority to U.S. Provisional Patent Application Serial No. 63/797,376, filed Apr. 30, 2025, the disclosure of which is expressly incorporated herein by reference.

### BACKGROUND AND SUMMARY OF THE DISCLOSURE

The present invention relates generally to electrolytic cells, including electrodes used in aqueous ozone generation. More particularly, the present disclosure relates to electrodes used within an ozone generator, and to methods for assembling and using the same.

Electrolytic ozone generation through water splitting is a highly effective method of creating ozonated (ozone) water for sanitization purposes. Regular tap water can be exposed to an electrically polarized catalyst, chemically transforming some fraction of water into dissolved, or aqueous, ozone molecules. One method for this technology is to place an ion exchange membrane between an anode and cathode. In most cases, the ion exchange membrane is formed of perfluoroalkyl and polyfluoroalkyl substances (PFAS), such as Nafion^{TM}. With government legislation moving to limit (or even remove) all PFAS materials from commercial products, alternative methods are being investigated. The purpose of the ion exchange membrane is to allow small ions to pass through for charge balance during electrolysis, but also to act as an electrically isolating barrier between the two electrodes, separating them at a very close distance to prevent direct shorting. In current designs, the anode and the cathode are typically formed as electrode plates. The plates each reside in a plastic frame and they are separated by the ion exchange (e.g., Nafion^{TM}) membrane.

The present invention may enable the ion exchange (e.g., Nafion^{TM}) membrane to be eliminated altogether. According to an illustrative embodiment of the present invention, one of the plastic frames a has very thin (0.001-0.003 inch thick) spacer, such as ribs, tabs or a surround that act to keep the frames separated (conserving electrical isolation), and that provide an open “window” to let the charge-balancing ions flow freely between the frames tolerances.

By eliminating the ion exchange membrane, an open space is created to let the charge-balancing ions pass freely therethrough. According to an illustrative embodiment, very thin separating tabs are positioned on the outside of the frames in a few spaced apart locations, and keep the electrodes separated at a precise distance. The closer the electrode surfaces are to each other, the less power is needed to run the system, especially in tap water where the low conductivity “electrolyte” can lead to significantly weaker electric fields between electrodes. The membranes of the prior art may also become contaminated with calcium, etc. over time and eventually fail. Thus, another benefit of eliminating the membrane is that there is no longer anything between the electrodes to become fouled. Depending on the thickness, size and material of the separating tabs, the tabs can be “burned” or “melted” using the generated heat of the system, and the electrodes thereby get closer together over time. The closer together the electrodes get, the greater the ozone concentration, and the better the electrodes perform over time. It may be possible to monitor this burning or melting of the tabs by measuring voltage and amperage, which also makes it possible to predict the end of life of the generator. The end of life would occur if the electrodes touch due to the tabs fully wearing away or degrading.

According to an illustrative embodiment of the present disclosure, an ozone generator for use with a fluid delivery device includes an outer cartridge and an electrolytic cell assembly received within the outer cartridge. The electrolytic cell assembly includes a first housing, and a first current spreader operably coupled to the first housing. The first current spreader includes a planar body and a terminal having a first electrical connection to a first wire lead. A first electrode is in electrical communication with the planar body of the first current spreader. A first frame receives the first electrode. The first housing and the outer cartridge cooperate to define a first water flow path across the first electrode. A second housing is operably coupled to the first housing. A second current spreader is operably coupled to the second housing. The second current spreader includes a planar body and a terminal having a second electrical connection to a second wire lead. A second electrode is in electrical communication with the planar body of the second current spreader. A second frame receives the second electrode and includes a spacer engaging the first frame and defining a desired distance between the first electrode and the second electrode. The second housing and the outer cartridge cooperate to define a second water flow path across the second electrode.

According to another illustrative embodiment of the present disclosure, an ozone generator for use with a fluid delivery device includes a first current spreader operably coupled to a first housing. The first current spreader includes a planar body and a planar terminal having an electrical connection to a first wire lead. A first electrode is operably coupled with the planar body of the first current spreader. A first frame receives the first electrode. A second current spreader is operably coupled to a second housing. The second current spreader includes a planar body and a planar terminal having an electrical connection to a second wire lead. A second electrode is operably coupled with the planar body of the second current spreader. A second frame receives the second electrode and includes a spacer engaging the first frame and defining a desired distance between the first electrode and the second electrode.

According to yet another illustrative embodiment of the present disclosure, an ozone generator for use with a fluid delivery device includes a first current spreader operably coupled to a first housing. The first current spreader includes a planar body and a round terminal having a first electrical connection to a first wire lead. An o-ring is received on the round terminal and provides a seal on the first current spreader between the planar body and the first electrical connection. A first electrode is operably coupled with the planar body of the first current spreader. A first frame receives the first electrode. A second current spreader is operably coupled to a second housing. The second current spreader includes a planar body and a round terminal having a second electrical connection to a second wire lead. An o-ring is received on the round terminal and provides a seal on the second current spreader between the planar body and the second electrical connection. A second electrode is operably coupled with the planar body of the second current spreader. A second frame receives the second electrode and includes a spacer engaging the first frame and defining a desired distance between the first electrode and the second electrode.

According to still another illustrative embodiment of the present disclosure, an ozone generator for use with a fluid delivery device includes an electrolytic cell assembly received within an outer cartridge. The electrolytic cell assembly includes an anode coupled to a first housing. A first frame receives the anode. A cathode is coupled to the second housing. A second frame receives the cathode. The first frame or the second frame includes a plurality of spacer engaging the other of the first frame and the second frame and defining a desired distance between the anode and the cathode.

According to a further illustrative embodiment of the present disclosure, an ozone generator for use with a fluid delivery device includes an electrolytic cell assembly received within an outer cartridge. The electrolytic cell assembly includes an anode coupled to a first housing. A first frame receives the anode. A cathode is coupled to a second housing. A second frame receives the cathode. The first frame or the second frame includes a plurality of spacers that defines a desired distance between the anode and the cathode. The first housing and the outer cartridge cooperate to define a first water flow path across the anode. The second housing and the outer cartridge cooperate to define a second water flow path across the cathode.

According to a still further illustrative embodiment of the present disclosure, an ozone generator for use with a fluid delivery device includes an electrolytic cell received within an outer cartridge. The electrolytic cell assembly includes a first current spreader overmolded by a first housing. An anode is in electrical communication with the first current spreader. A first frame receives the anode. A second current spreader is overmolded by a second housing. A cathode is in electrical communication with the second current spreader. A second frame receives the cathode. The first frame or the second frame includes a spacer defining a desired distance between the anode and the cathode.

According to another illustrative embodiment of the present disclosure, an ozone generator for use with a fluid delivery device includes an electrolytic cell received within an outer cartridge. The electrolytic cell assembly includes a first current spreader overmolded by a first housing. An anode is in electrical communication with the first current spreader. A first frame receives the anode. A second current spreader is overmolded by a second housing. A cathode is in electrical communication with the second current spreader. A second frame receives the cathode. The first frame or the second frame includes a plurality of spacers engaging the other of the first frame and the second frame. The spacers define a gap having a desired width between the anode and the cathode. The first current spreader includes a first terminal and a first opening that receives the anode. The first housing surrounds the first current spreader in a sealed manner between the first terminal and the first opening. The second current spreader includes a second terminal and a second opening that receives the cathode. The second housing surrounds the second current spreader in a sealed manner between the second terminal and the second opening.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description of exemplary embodiments when taken in conjunction with the accompanying drawings, wherein:

FIG. 1 is an assembled, upper perspective view of an exemplary ozone generator of the present disclosure;

FIG. 2 is a cross-sectional view taken along line 2-2 of the ozone generator of FIG. 1;

FIG. 3 is an enlargement of area 3 in FIG. 2;

FIG. 4 is a further enlargement of FIG. 3;

FIG. 5 is a cross-sectional view taken along line 5-5 of the ozone generator of FIG. 1;

FIG. 6 is an exploded perspective view of the ozone generator of FIG. 1, the ozone generator including first and second housings, first and second current spreaders, first and second frames, and first and second electrodes;

FIG. 7 is an upper perspective view of the electrolytic cell assembly of the ozone generator of FIG. 1;

FIG. 8 is an upper perspective, partially exploded view of the electrolytic cell assembly of FIG. 7;

FIG. 9 is an upper perspective, cross-sectional view of the ozone generator of FIG. 1 along line 9-9;

FIG. 10 is an enlargement of area 10 in FIG. 9;

FIG. 11 is a further enlargement of FIG. 10;

FIG. 12 is an upper perspective view of a frame and an electrode of the electrolytic cell assembly of FIG. 7;

FIG. 13 is an upper perspective view of the frames, an electrode, a current spreader, and a housing of the electrolytic cell assembly of FIG. 7;

FIG. 14 is a schematic view of the ozone generator of FIG. 1 in fluid communication with a faucet;

FIG. 15 is an exploded perspective view of a further illustrative ozone generator;

FIG. 16A is a perspective view of the illustrative spacer of the ozone generator of FIG. 15;

FIG. 16B is a perspective view of another illustrative spacer;

FIG. 16C is a perspective view of a further illustrative spacer; and

FIG. 16D is a perspective view of another illustrative spacer.

### DETAILED DESCRIPTION OF THE DRAWINGS

For the purposes of promoting and understanding the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

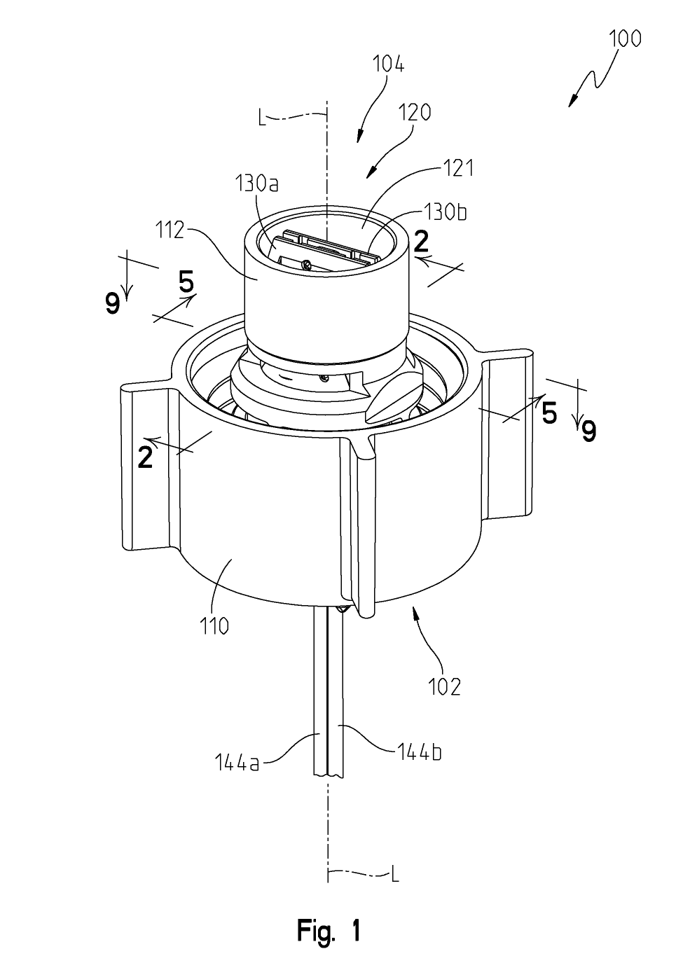

An exemplary ozone generator 100 of the present disclosure is shown in FIGS. 1-2 and 5-6. The illustrative ozone generator 100 has an inlet end 102, an outlet end 104, and a longitudinal axis L extending therebetween.

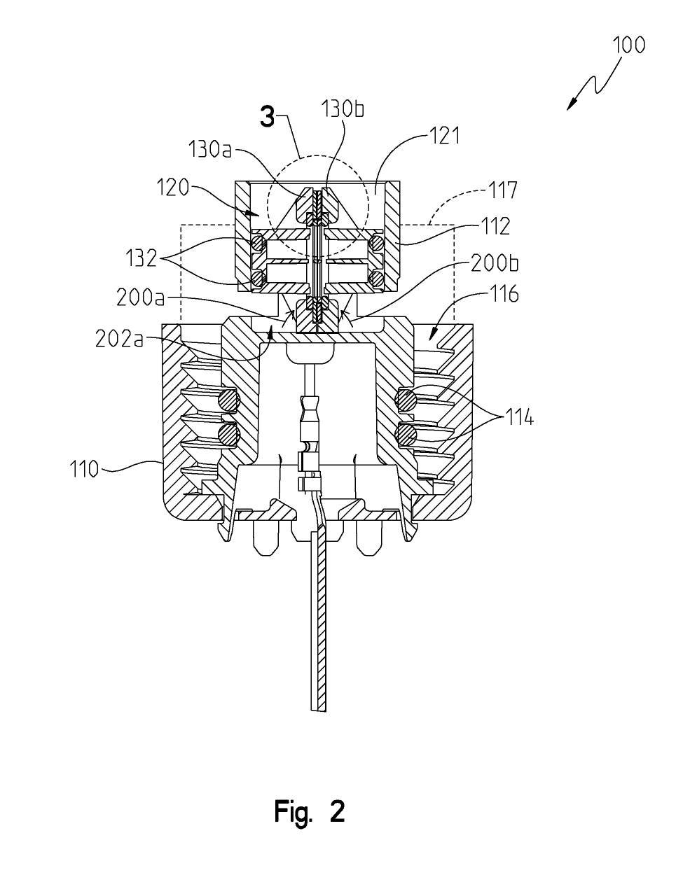

As shown in FIGS. 1-2 and 5-6, the illustrative ozone generator 100 includes an outer pipe fitting 110, an outer cylindrical cartridge 112, and one or more outer sealing rings 114 surrounding the cartridge 112. The pipe fitting 110 and the cartridge 112 define a space 116 therebetween for receiving a fluid pipe 117 therein (FIG. 2). More particularly, the illustrative pipe fitting 110 is internally threaded to mate with the externally threaded fluid pipe 117. The sealing rings 114, illustratively elastomeric o-rings, promote a sealed connection between the pipe fitting 110, the cartridge 112, and the fluid pipe 117.

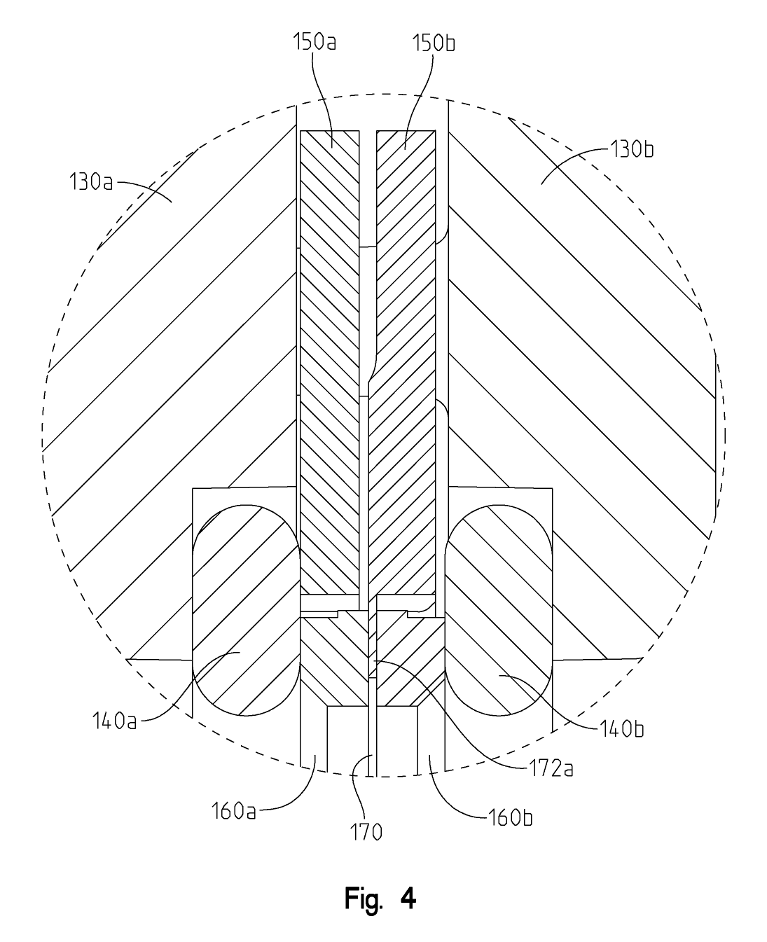

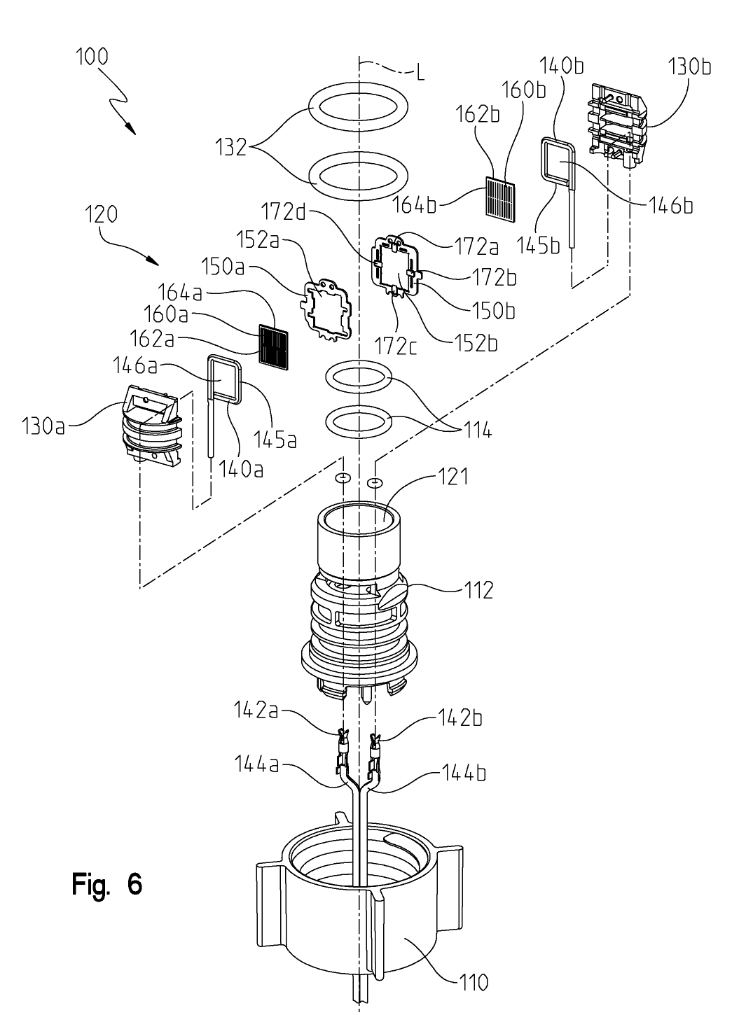

As shown in FIG. 6, the ozone generator 100 further includes an electrolytic cell assembly 120 located inside a cavity 121 of the cartridge 112. The illustrative electrolytic cell assembly 120 includes a first housing or carrier 130a and a second housing or carrier 130b, a first current spreader 140a and a second current spreader 140b, a first frame 150a and a second frame 150b, a first electrode 160a and a second electrode 160b. Each component of the electrolytic cell assembly 120 is described further below with further reference to FIG. 4.

The first and second housings 130a, 130b of the electrolytic cell assembly 120 are compressed together with the other components of the electrolytic cell assembly 120 being mechanically and electrically sandwiched therebetween. In FIG. 4, one or more sealing rings 132, illustratively elastomeric o-rings, are positioned around the housings 130a, 130b to hold the housings 130a, 130b together. Each housing 130a, 130b may be generally rectangular in cross-section except for the areas of rings 132, which may be generally semi-circular in cross-section. According to an exemplary embodiment of the present disclosure, the housings 130a, 130b are held together by the sealing rings 132 independently of the outer cartridge 112 to facilitate storage and assembly of the electrolytic cell assembly 112, with or without cartridge 112 in place. It is also within the scope of the present disclosure that the first and second housings 130a, 130b may be clamped, fastened, or otherwise held together. The housings 130a, 130b are constructed of an electrically insulating material, such as a polymer. An exemplary polymer is the Udel® P-1700 polysulfone material available from Solvay Plastics.

The first and second current spreaders 140a, 140b of the electrolytic cell assembly 120 mate with the first and second housings 130a, 130b, respectively. According to an exemplary embodiment of the present disclosure, the first and second housings 130a, 130b are press-fit onto the first and second current spreaders 140a, 140b, respectively, to form pre-assembled components. The o-rings 132 hold together the housings 130a, 130b in a clam-shell manner and apply a slight compression on the electrolytic cell assembly 120 (to make sure there is ample contact of the spreaders 140a, 140b to the electrodes 160a, 160b) without overloading and breaking the electrodes 160a, 160b after being pushed into the cavity 121 of the cartridge 112.

In other illustrative embodiments, the housings 130a, 130b are coupled to the current spreaders 140a, 140b, respectively, using other conventional securement means, such as adhesives, fasteners and/or overmolding.

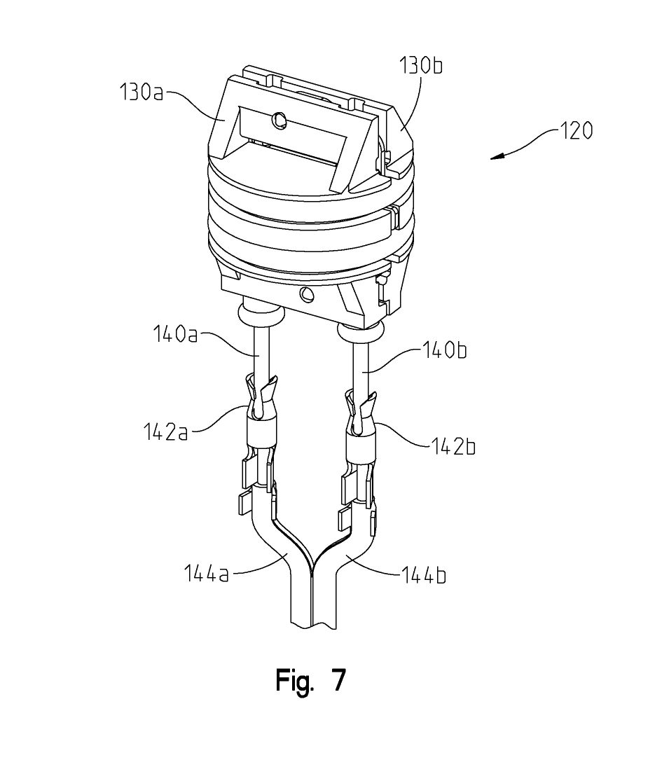

The illustrative current spreaders 140a, 140b are constructed of an electrically conductive material, such as titanium or another suitable material. The first current spreader 140a includes a first terminal 142a that extends out of the first housing 130a in a sealed manner for electrical communication with a first wire lead 144a, as shown in FIG. 7. Likewise, the second current spreader 140b includes a second terminal 142b that extends out of the second housing 130b in a sealed manner for electrical communication with a second wire lead 144b.

The first current spreader 140a also includes a first rectangular body 145a defining a first opening 146a that is sized and shaped to receive and expose the first electrode 160a, as discussed further below. Likewise, the second current spreader 140b includes a second rectangular body 145b defining a second opening 146b that is sized and shaped to receive and expose the second electrode 160b, as discussed further below.

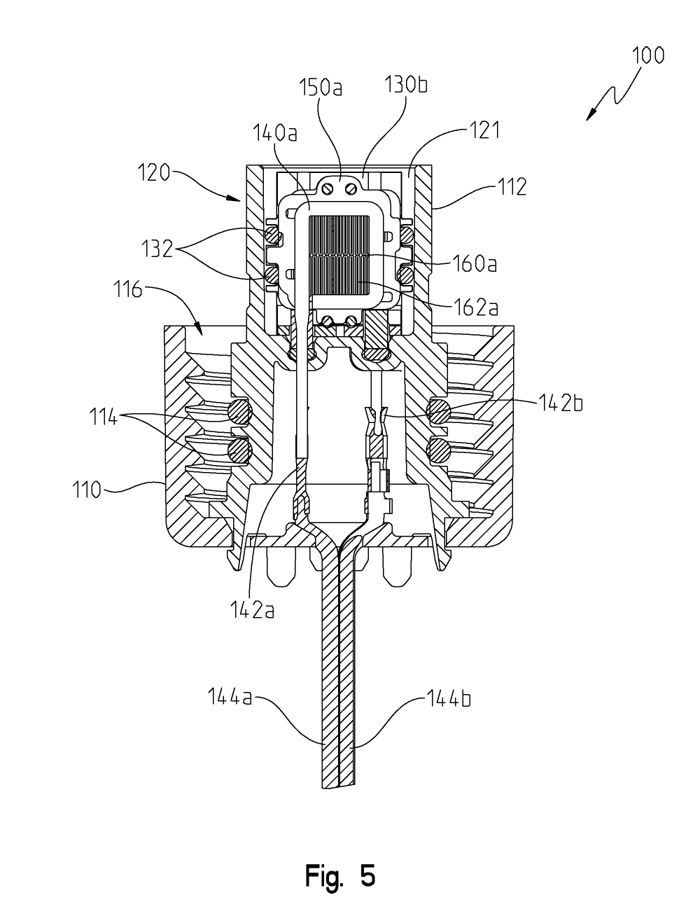

The bodies 145a and 145b are illustratively planar wherein the openings 146a, 146b in the current spreaders 140a, 140b may be flush with the surrounding housings 130a, 130b. Between the first terminal 142a and the first opening 146a, the first current spreader 140a may be surrounded by the overmolded material of the first housing 130a in a sealed manner, as shown in FIG. 5. Likewise, between the second terminal 142b and the second opening 146b, the second current spreader 140b may be surrounded by the overmolded material of the second housing 130b in a sealed manner.

The first and second frames 150a, 150b of the electrolytic cell assembly 120 mate with the first and second housings 130a, 130b, respectively. The frames 150a, 150b are illustratively constructed of an electrically insulating material, such as a polymer including no perfluoroalkyl and polyfluoroalkyl substances (PFAS). An exemplary polymer is the Udel® P-1700 polysulfone material available from Solvay Plastics. The first frame 150a includes a first opening 152a that is sized and shaped to receive the first electrode 160a in electrical communication with the first current spreader 140a. Likewise, the second frame 150b includes a second opening 152b that is sized and shaped to receive the second electrode 160b in electrical communication with the second current spreader 140b. The first and second frames 150a, 150b may cooperate with the first and second overmolded housings 130a, 130b to otherwise shield or insulate the first and second current spreaders 140a, 140b, respectively, to prevent electrical contact between the first and second current spreaders 140a, 140b.

The illustrative first and second electrodes 160a, 160b of the electrolytic cell assembly 120 are received within the first and second frames 150a, 150b, respectively. Each electrode 160a, 160b may have a back side 162a, 162b that interacts with the adjacent current spreader 140a, 140b, respectively. The front sides 164a, 164b of respective electrode 160a, 160b face each other. An exemplary electrode 160a, 160b is constructed of boron-doped silicon or another suitable material. The boron doped silicon material serves as a conductor to pass current between the current spreaders 140a, 140b. The boron doped silicon material may be about 200-800 microns thick, such as about 500 microns thick. The front side 164a, 164b of each electrode 160a, 160b may have a boron-doped diamond coating or another suitable coating. The coating may be about 2-10 microns thick. For proper operation of the ozone generator 100, the coated tides 164a, 164b must face each other. The coating may be applied to the underlying silicon material by chemical vapor deposition (CVD) or another suitable deposition technique. The illustrative electrodes 160a, 160b are generally rectangular in shape, having a width of about 8 millimeters and a length of about 10 millimeters, although the size and shape of the electrodes 160a, 160b may vary.

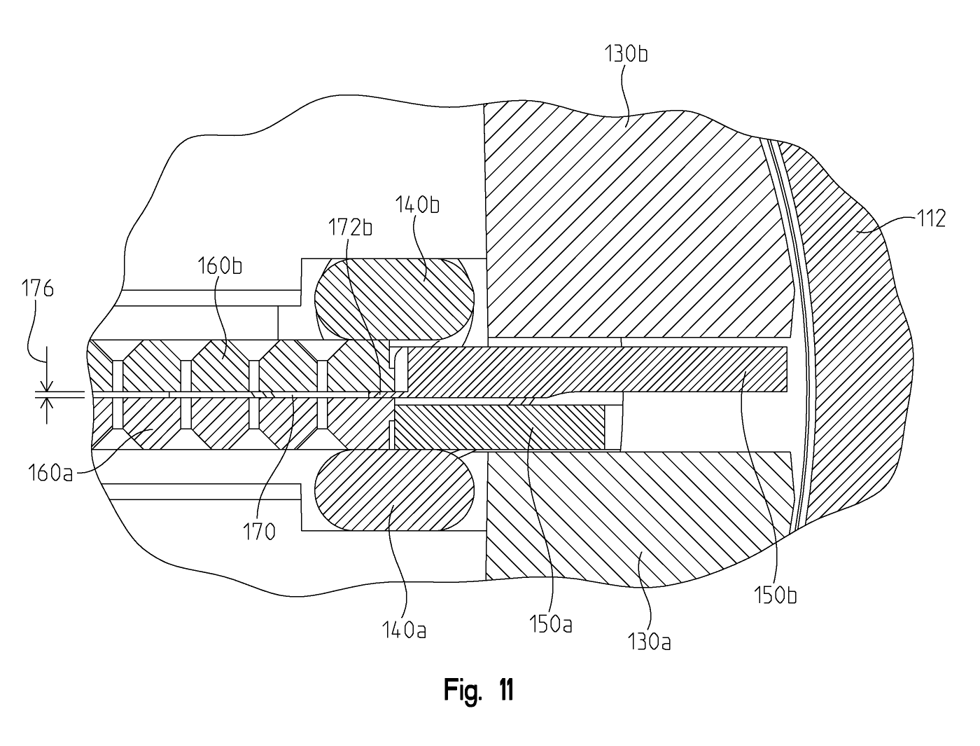

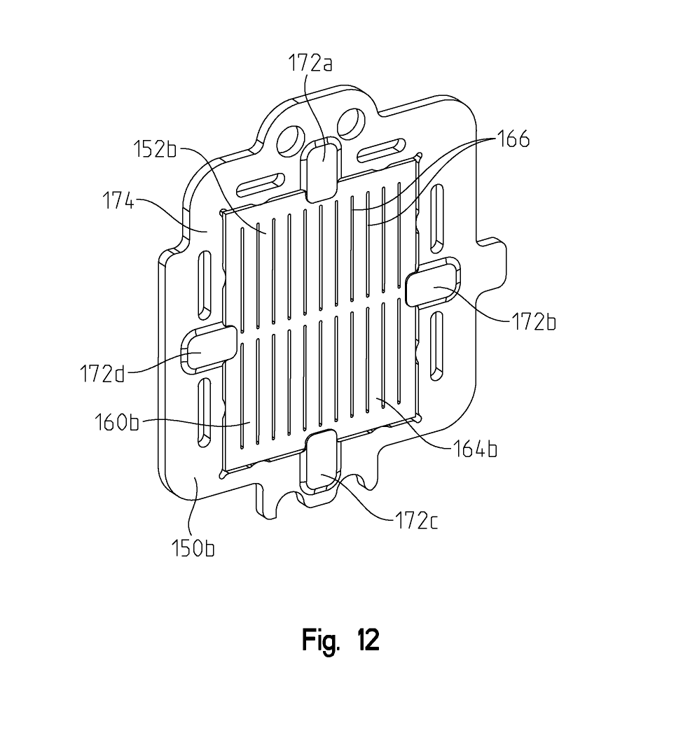

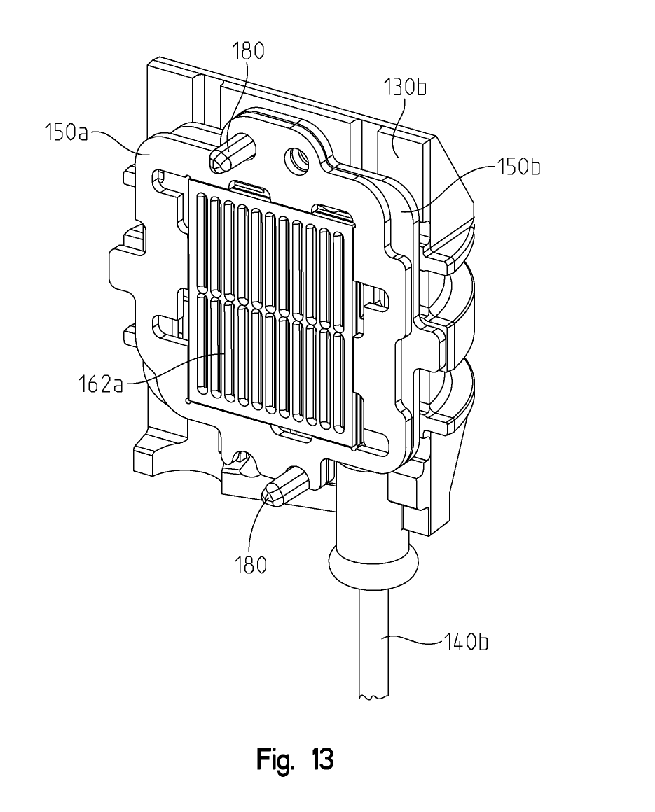

As discussed further below, the electrodes 160a, 160b communicate with the water flowing through the electrolytic cell assembly 120. Each electrode 160a, 160b may include a plurality of water passageways 166 (FIG. 12; e.g., slots) to increase the exposed surface area of each electrode 160a, 160b for communication with water and to allow water flow through each electrode 160a, 160b. To allow for precise control of their size and shape, the water passageways 166 may be formed using deep reactive ion etching (DRIE) or another suitable technique.

Additional details of illustrative electrodes 160 are provided in U.S. Patent No. 10,767,270 to Jonte et al., entitled “Electrode for an Ozone Generator”, the entire disclosure of which is expressly incorporated herein by reference.

A fluid gap 170 (FIGS. 4 and 11) illustratively separates the first and second electrodes 160a, 160b by a desired distance, illustratively an initially fixed distance of about 0.001-0.003 inch. Illustratively, the gap 170 is occupied by air when initially assembled, and occupied by water when in operation. The fluid gap 170 allows protons to be conducted between the electrodes 160a, 160b. In order to provide the fluid gap 170 with a desired width, the second frame 150b illustratively includes spacers, such as ribs or tabs 172a-d (FIG. 12) on its surface 174 that faces the first frame 150a. The illustrative spacers 172a-d are formed integral with the frame 150b and may be formed of non-PFAS materials, such as a molded polymer. The spacers 172a-d may be evenly spaced around the perimeter of the opening 152b of the frame 150b and straddle the perimeter of the opening 152b such that the spacers 172a-d are partially superimposed over the opening 152b. The illustrative spacers 172a-d each have a thickness 176 (FIG. 11) of approximately between 0.001-0.003 inch to maintain the fluid gap 170 at an identical distance or width of approximately between 0.001-0.003 inch when spacers 172a-d engage and are biased against the first frame 150a.

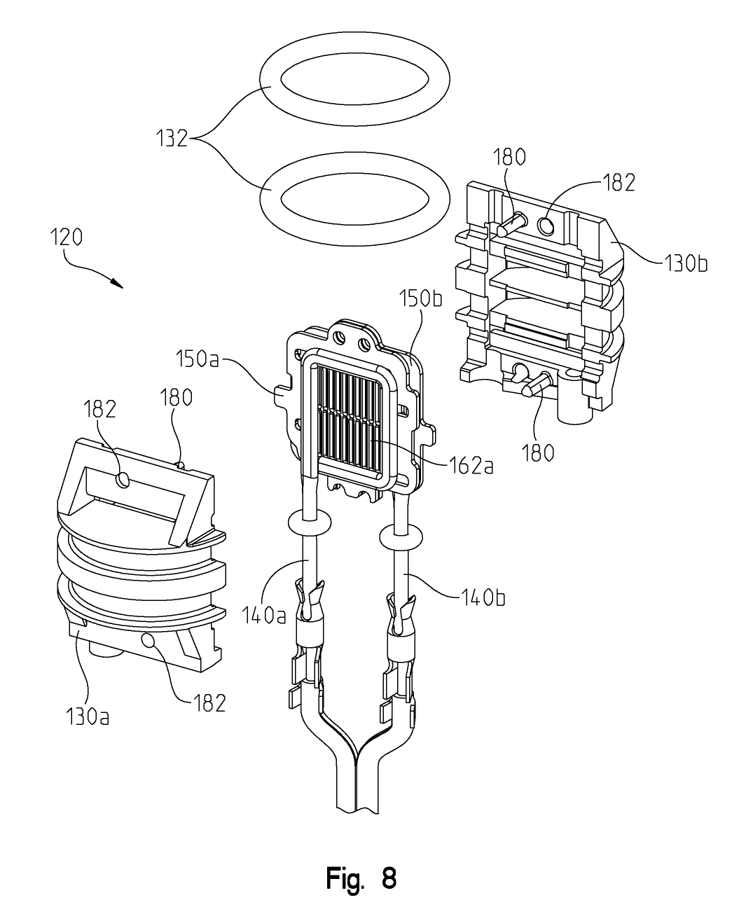

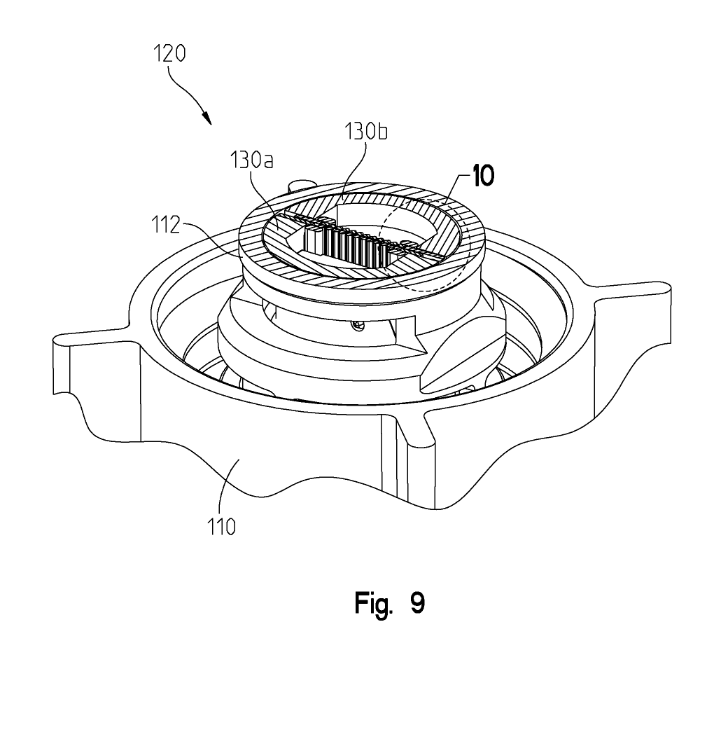

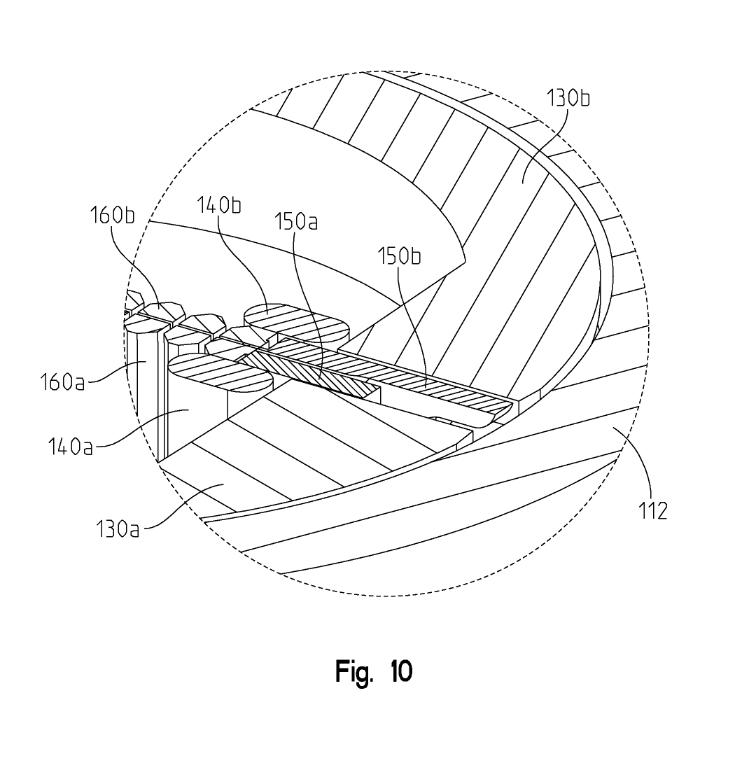

The components of the electrolytic cell assembly 120 may include registration features to facilitate the assembly process and, once assembled, to produce stable mechanical connections between the components. For example, the first housing 130a may include one or more posts 180 (FIG. 8) that register with corresponding holes 182 in the second housing 130b.

Corresponding components of the electrolytic cell assembly 120 may be identical in construction and rotated into the desired orientation. As shown in FIG. 6, the same housing component may be placed in a first orientation for use as the first housing 130a or rotated 180 degrees about the longitudinal axis L for use as the second housing 130b. The housing component may have opposite registration features located on opposite sides of the longitudinal axis L such that, when rotated, the registration posts 180 on the first housing 130a correspond with the registration holes 182 in the second housing 130b, and vice versa. As also shown in FIG. 6, the same current spreader component may be placed in a first orientation for use as the first current spreader 140a or rotated 180 degrees about the longitudinal axis L for use as the second current spreader 140b. Advantageously, these identical constructions may reduce manufacturing, inventory, and replacement costs and may facilitate the assembly process.

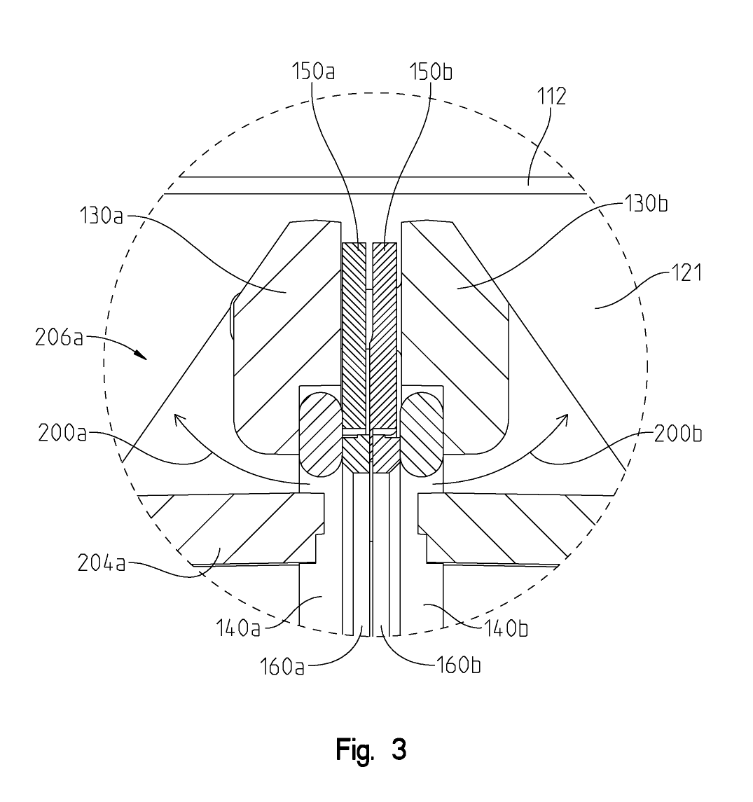

Returning to FIGS. 2 and 3, the illustrative ozone generator 100 defines a first water flow path 200a in fluid communication with the first electrode 160a and a second water flow path 200b in fluid communication with the second electrode 160b. The first water flow path 200a is illustratively formed between the outer cartridge 112 and the first housing 130a, and the second water flow path 200b is illustratively formed between the outer cartridge 112 and the second housing 130b. Advantageously, forming the flow paths 200a, 200b between the cartridge 112 and the housings 130a, 130b may ease mold design, tooling, and molding. Also, forming the flow paths 200a, 200b between the cartridge 112 and the housings 130a, 130b may take advantage of the sealing rings 132 around the housings 130a, 130b to force the water flow through the desired flow paths 200a, 200b, not freely around the housings 130a, 130b.

The first water flow path 200a is described further herein, but the same description may apply to the second water flow path 200b. In FIG. 2, the first water flow path 200a begins at a first inlet 202a and travels around a first ribbed barrier 204a that projects inwardly from the first housing 130a. Specifically, the first water flow path 200 a travels: (1) toward the back side 162a of the first electrode 160a in a direction perpendicular to the first electrode 160a and the longitudinal axis L, (2) around a 90 degree bend, (3) across the back side 162a of the first electrode 160a in a direction parallel to the first electrode 160a and the longitudinal axis L, (4) around another 90 degree bend, and (5) away from the back side 162a of the first electrode 160a in a direction perpendicular to the first electrode 160a and the longitudinal axis L. Finally, the first water flow path 200a travels to a first outlet 206a located in the longitudinal end of the cartridge 112. Upon exiting the cartridge 112, the first water flow path 200a may re-combine with the second water flow path 200b.

The water flow paths 200a, 200b may be designed to create high water velocity with low turbulence across the electrodes 160a, 160b. Creating a high water velocity may help flush away bubbles from the electrodes 160a, 160b when the bubbles are still small in size, before they have time to rest and expand, thereby making room for more water to contact the electrodes 160a, 160b, avoiding bubble attachment on the electrodes 160a, 160b, and avoiding entrapment of gas products in large bubbles. In certain illustrative embodiments, the height of the gap or clearance 208a between the first barrier 204a in the first housing 130a and the back side 162a of the first electrode 160a may be controlled to optimize the water flow therebetween.

In operation, electric current is applied to the electrodes 160a, 160b causing electrolysis to occur in the electrolytic cell assembly 120. Specifically, a positive electric potential is applied to one electrode (e.g., the first electrode 160a) to form an anode, and a negative electric potential is applied to the other electrode (e.g., the second electrode 160b) to form a cathode. As a result, a voltage differential may be produced across the first electrode 160a and the second electrode 160b. The electric potential may be applied using a power source (not shown), which may be coupled to the first and second terminals 142a, 142b via first and second leads 144a, 144b, respectively. The water flowing through the electrolytic cell assembly 120 may serve as the electrolytic solution without the need for an additional electrolytic solution.

At the positive anode (e.g., the first electrode 160a), the water is electrolyzed and broken down into oxygen ions and hydrogen ions. At least some of the oxygen ions are converted to ozone (O₃) due to the higher over-potential voltage of the conductive diamond coating on the anode. The ozone may dissolve into the water to perform a disinfecting function in the water. The remaining oxygen ions may be converted to more stable oxygen (O₂), which may have little value in this application. Electrons from the electrolyzed water are transported to the cathode (e.g., the second electrode 160b) via the leads 144a, 144b, while hydrogen ions (i.e., protons) from the electrolyzed water are transported to the cathode across the fluid gap 170. At the cathode, the hydrogen ions and the electrons from the electrolyzed water recombine to form hydrogen (H₂) bubbles. The water streams passing over the electrodes 160a, 160b sweep away the O₃ and O₂ from the anode and the H₂ from the cathode. The same water streams also supply fresh water to replenish the water consumed during electrolysis.

In certain illustrative embodiments, the polarity of the electrolytic cell assembly 120 may be selectively reversed to reduce scale build-up. In a first state, the first electrode 160a may serve as the anode, and the second electrode 160b may serve as the cathode, for example. In a second state, the first electrode 160a may be switched from the anode to the cathode, and the second electrode 160b may be switched from the cathode to the anode. The reversed state may also force water through the fluid gap 170 to pre-hydrate the anode upon return to the first state. The duration of the reversed state may be relatively short, such as about 20 seconds or less.

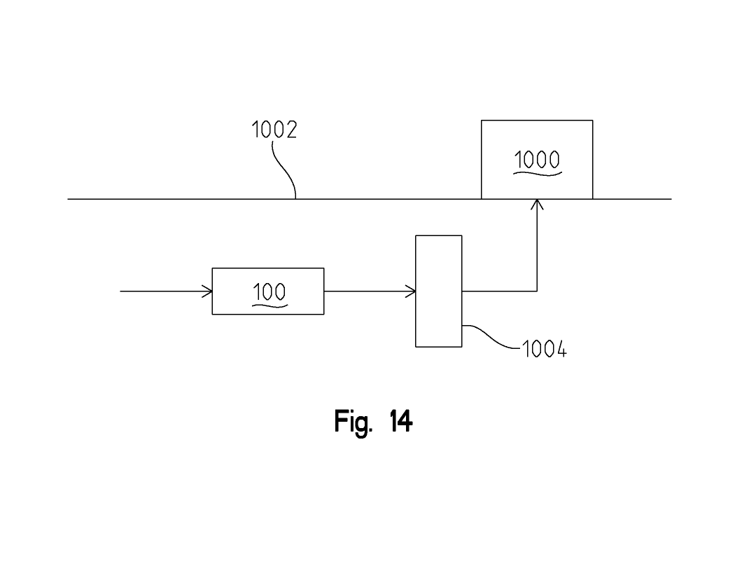

Referring next to FIG. 14, the ozone generator 100 may be installed in fluid communication with a fluid delivery device, such as a faucet 1000. For example, the ozone generator 100 may be installed beneath a sink deck 1002 in fluid communication with the faucet 1000. In certain illustrative embodiments, the ozone generated by the ozone generator 100 may remain in the water upon reaching the faucet 1000 to continue performing the disinfecting function. In this illustrative embodiment, the ozone-containing water from the faucet 1000 may be used as a disinfectant or a cleaning agent, for example. In other illustrative embodiments, the ozone generated by the ozone generator 100 may perform an initial disinfecting function in the water but, before reaching the faucet 1000, the ozone may be destroyed or otherwise removed from the water. For example, as shown in FIG. 14, a filter 1004 (e.g., a carbon black filter) may be provided downstream of the ozone generator 100 and upstream of the faucet 1000, which gives the ozone from the ozone generator 100 time to initially treat the water before being removed by the filter 1004. In this illustrative embodiment, the treated water from the faucet 1000 may be used as drinking water, for example.

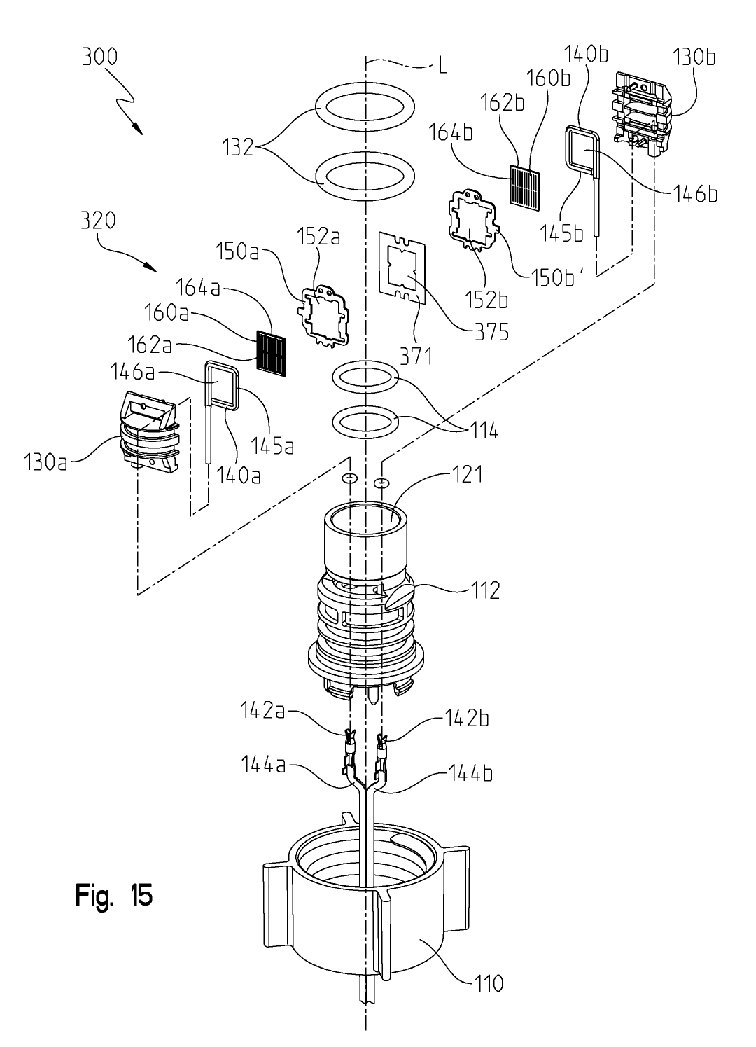

A further illustrative embodiment ozone generator 300 is shown in FIG. 15. The ozone generator 300 includes many of the same components as ozone generator 100 detailed above. As such, in the following description similar components are identified with like reference numbers.

The illustrative ozone generator 300 (FIG. 15) includes an electrolytic cell assembly 320 that differs from the electrolytic cell assembly 120 of the ozone generator 100 (FIG. 6). More particularly, the illustrative electrolytic cell assembly 320 includes first housing or carrier 130a and second housing or carrier 130b, first current spreader 140a and second current spreader 140b, and first electrode 160a and second electrode 160b. Each of these components of the electrolytic cell assembly 320 is described in further detail above with reference to FIG. 4.

The second frame 150b of the electrolytic cell assembly 120 of FIG. 6 is replaced with a second frame 150b' in the electrolytic cell assembly 320 of FIG. 15. Illustratively, the second frame 150b' is substantially identical to the first frame 150a. The first frameb 150a includes first opening 152a that is sized and shaped to receive the first electrode 160a in electrical communication with the first current spreader 140a. Likewise, the second frame 150b' includes second opening 152b that is sized and shaped to receive the second electrode 160b in electrical communication with the second current spreader 140b.

Illustratively, a separator 371 is positioned intermediate the first frame 150a and the second frame 150b' thereby defining the fluid gap 170 with a desired, initially fixed distance (illustratively, of about 0.001-0.003 inch) between the first electrode 160a and the second electrode 160b. In other words, the separator 371 serves a similar function as the spacers 172a-d on the surface 174 of the second frame 150b of the electrolytic cell assembly 120 (FIG. 12).

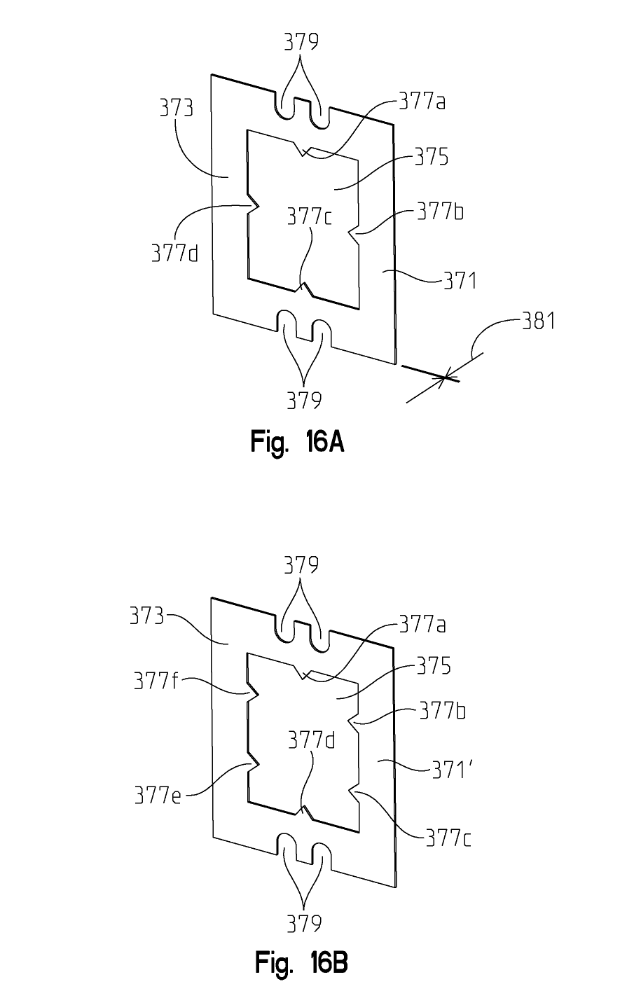

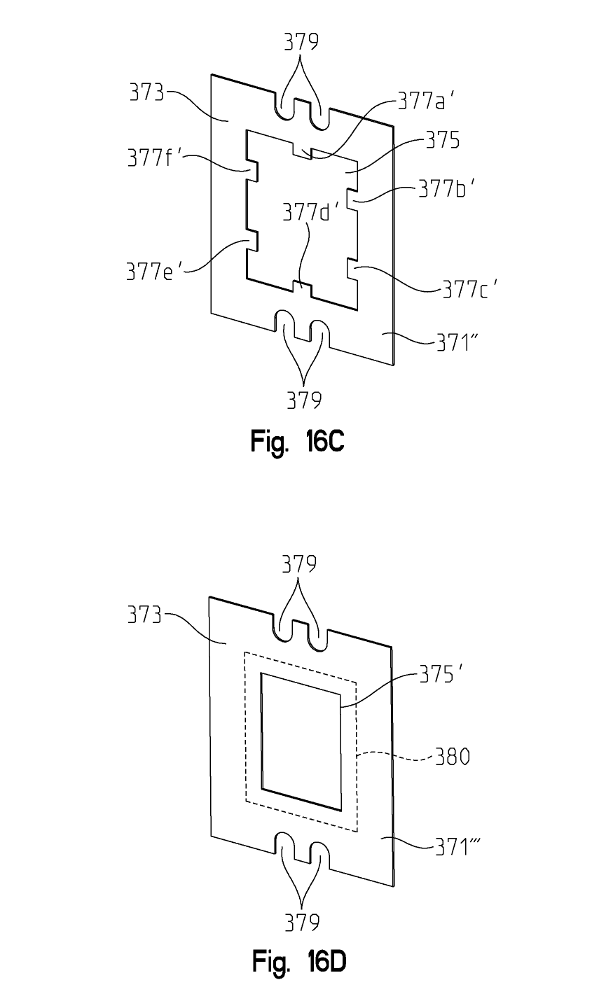

FIG. 16A shows additional details of the illustrative separator 371 as including an outer body 373 defining a central opening or window 375. A plurality of projections or tabs 377a, 377b, 377c, 377d are supported by the body 373 and extend inwardly into the central opening 375. The illustrative tabs 377a, 377b, 377c, 377d have a triangular shape in order to limit covering facing surface areas of the associated electrodes 160a, 160b. Illustratively, the number, shape and positioning of tabs 377 may be selected to provide effective separation between the electrodes 160a, 160b while limiting surface area coverage thereof. More particularly, parameters of the tabs 377 are selected to maintain a desired close separation (via the fluid gap 170) between the electrodes 160a, 160b, while limiting contact area with the electrodes 160a, 160b, thereby providing for efficient operation of the ozone generator 300.

The illustrative separator 371 of FIG. 16A includes four tabs 377 of a triangular shape, while the illustrative separator 371' of FIG. 16B includes six tabs 377 of triangular shape. The illustrative separator 371'' of FIG. 16C includes six tabs 377' of a rectangular shape.

As noted above, the number and spacing of tabs 377' may vary. FIG. 16D shows another illustrative embodiment separator 371''' where spacing between the tabs 377' is eliminated such that the tabs 377' merge together to define a rectangular surround 380 extending inwardly into the central opening 375. In other illustrative embodiment separators 371, the opening 375 may be replaced by a plurality of different openings or windows of different shapes and/or sizes. For example, various cross or fence members may define such different openings.

The outer body 373 may include recesses or notches 379 to assist with locating and aligning the separator 371, 371', 371'', 371''' in the respective electrolytic cell assembly 320. The separator 371, 371', 371'', 371''' may be formed of a non-PFAS material, illustratively a polymer that is high temperature and chemical resistant. According to an illustrative embodiment, the separator 371, 371', 371'', 371''' may be formed of a polyimide film (e.g., Kapton^{®}, available from DuPont) or polyetherimide (PEI) thermoplastic resin (e.g., Ultem^{®}, available from Curbell Plastics).

Illustratively, the separator 371, 371', 371'', 371''' has a thickness 381 of approximately between 0.001-0.003 inch to maintain the fluid gap 170 at an identical distance or width of approximately between 0.001-0.003 inch when the separator 371, 371', 371'', 371''' engages and is biased against the first frame 150a and the second frame 150b'.

Additional information regarding an illustrative use of the ozone generator 100 is disclosed in U.S. Patent No. 9,919,939 to Rosko et al., entitled “Ozone Distribution in a Faucet”, and U.S. Patent No. 11,220,754 to Jonte et al., entitled “Ozone Generator for a Faucet”, the entire disclosures of which are expressly incorporated herein by reference.

While the above description details use of an electrolytic cell assembly 120, 320 of an ozone generator 100, 300 for use within a faucet, it should be appreciated that the present invention may be used in a variety of fluid delivery devices, including various plumbing products (e.g., bidets, toilets, showerheads, etc.). The present invention may also be used in connection with products not related to plumbing (e.g., fuel cells).

Although the invention has been described in detail with reference to certain preferred embodiments, variations and modifications exist within the spirit and scope of the invention as described and defined in the following claims.

What is claimed is:

1. An ozone generator comprising:
an outer cartridge; and
an electrolytic cell assembly received within the outer cartridge, the electrolytic cell assembly including:
a first housing;
a first current spreader operably coupled to the first housing, the first current spreader including a planar body and a terminal having a first electrical connection to a first wire lead;
a first electrode in electrical communication with the planar body of the first current spreader;
a first frame receiving the first electrode;
wherein the first housing and the outer cartridge cooperate to define a first water flow path across the first electrode;
a second housing operably coupled to the first housing;
a second current spreader operably coupled to the second housing, the second current spreader including a planar body and a terminal having a second electrical connection to a second wire lead;
a second electrode in electrical communication with the planar body of the second current spreader;
a second frame receiving the second electrode; and
at least one spacer configured to engage the first frame and define a gap with a desired distance between the first electrode and the second electrode;
wherein the second housing and the outer cartridge cooperate to define a second water flow path across the second electrode.

2. The ozone generator of claim 1, wherein the second frame defines the at least one spacer.

3. The ozone generator of claim 1, wherein the at least one spacer is defined by a separator including an outer body having a center opening, and a plurality of tabs extending inwardly from the outer body.

4. The ozone generator of claim 1, wherein the planar body of the first current spreader is sealed from the first electrical connection between the terminal of the first current spreader and the first wire lead, and the first electrical connection is outside of the first water flow path, and wherein the planar body of the second current spreader is sealed from the second electrical connection between the terminal of the second current spreader and the second wire lead, and the second electrical connection is outside of the second water flow path.

5. The ozone generator of claim 1, wherein the first electrode and the second electrode each comprises an underlayer of boron-doped silicon and a coating of boron-doped diamond.

6. The ozone generator of claim 1, wherein the first current spreader is positioned intermediate the first housing and the first electrode, and the second current spreader is positioned intermediate the second housing and the second electrode.

7. The ozone generator of claim 1, wherein the terminal of the first current spreader includes tabs configured to be crimped on the first wire lead, and the terminal of the second current spreader includes tabs configured to be crimped on the second wire lead.

8. The ozone generator of claim 1, wherein each terminal of the first current spreader and the second current spreader has a round cross-section and an o-ring received on the terminal.

9. The ozone generator of claim 1, wherein there is a fluid gap between the first electrode and the second electrode.

10. The ozone generator of claim 1, wherein the spacer is formed of a non-PFAS (perfluoroalkyl and polyfluoroalkyl substance) material.

11. An ozone generator for use with a fluid delivery device, the ozone generator comprising:
an outer cartridge;
an electrolytic cell assembly received within the outer cartridge, the electrolytic cell assembly comprising:
a first housing;
an anode coupled to the first housing;
a first frame receiving the anode;
a second housing;
a cathode coupled to the second housing;
a second frame receiving the cathode;
wherein:
at least one of the first frame and the second frame includes a plurality of spacers configured to define a desired distance between the anode and the cathode;
the first housing and the outer cartridge cooperate to define a first water flow path across the anode; and
the second housing and the outer cartridge cooperate to define a second water flow path across the cathode.

12. The ozone generator of claim 11, further comprising a first current spreader positioned intermediate the first housing and the anode, and a second current spreader positioned intermediate the second housing and the cathode.

13. The ozone generator of claim 12, wherein each of the first current spreader and the second current spreader includes a rectangular body and a terminal configured to be in electrical communication with a wire lead, the rectangular body of the first current spreader being overmolded with the first housing, and the rectangular body of the second current spreader being overmolded with the second housing.

14. The ozone generator of claim 12, wherein each of the first current spreader and the second current spreader includes a rectangular body and a terminal configured to be in electrical communication with a wire lead, each terminal having a round cross-section and an o-ring received on the terminal.

15. The ozone generator of claim 11, wherein the plurality of spacers are formed of a non-PFAS (perfluoralkyl and polyfluroalkyl substance) material.

16. An ozone generator for use with a fluid delivery device, the ozone generator comprising:
an outer cartridge;
an electrolytic cell received within the outer cartridge, the electrolytic cell assembly including:
a first housing;
a first current spreader overmolded by the first housing,
an anode in electrical communication with the first current spreader;
a first frame receiving the anode;
a second housing;
a second current spreader overmolded by the second housing,
a cathode in electrical communication with the second current spreader; and
a second frame receiving the cathode;
wherein at least one of the first frame and the second frame includes at least one spacer configured to define a desired distance between the anode and the cathode.

17. The ozone generator of claim 16, wherein the anode and the cathode each comprises a plurality of water passageways.

18. The ozone generator of claim 16, wherein the water passageways are formed by deep reactive ion etching.

19. The ozone generator of claim 16, wherein the first housing and the second housing are identical in construction.

20. The ozone generator of claim 16, wherein the at least one spacer is formed of a non-PFAS (perfluoralkyl and polyfluroalkyl substance) material.
